(19) United States
(12) Patent Application Publication
(10) Pub. No.: US 2023/0132024 A1
(43) Pub. Date: Apr. 27, 2023

(54) MAGNETIC ABRASIVE FINISHING USING STATIONARY ELECTROMAGNETS

(71) Applicants: Azeem Singh Kahlon, London (CA); Mir Behrad Khamesee, Waterloo (CA); Mohammad Saeed Sepasy Zahmaty, Hachioji (JP); Saori Nakagawa, Yotsukaido (JP)

(72) Inventors: Azeem Singh Kahlon, London (CA); Mir Behrad Khamesee, Waterloo (CA); Mohammad Saeed Sepasy Zahmaty, Hachioji (JP); Saori Nakagawa, Yotsukaido (JP)

(21) Appl. No.: 18/045,911

(22) Filed: Oct. 12, 2022

Related U.S. Application Data
(60) Provisional application No. 63/262,500, filed on Oct. 14, 2021.

(51) Int. Cl. B24C 1/08; H01F 7/20; H01F 7/06

(52) U.S. Cl. CPC B24C 1/08; H01F 7/20; H01F 7/064

(57) ABSTRACT

Methods, apparatus, and systems for magnetic field assisted abrasive finishing of a workpiece are provided. A stationary electromagnetic array comprised of iron core electromagnets is positioned adjacent a workpiece to generate a dynamic magnetic field. A control system is adapted to be programmed to selectively energize the electromagnets of the stationary electromagnetic array to generate the dynamic magnetic field. The dynamic magnetic field may comprise one of a rotating magnetic field, an oscillating magnetic field, or a designated pattern. A plurality of magnetic abrasive particles is also provided. A jig is provided to position the stationary electromagnetic array relative to the workpiece. The plurality of magnetic abrasive particles are introduced into the dynamic magnetic field and are caused to move relative to a surface of the workpiece by the dynamic magnetic field.

This application claims the benefit of U.S. Provisional Application No. 63/262,500 filed on Oct. 14, 2021, which is incorporated herein and made a part hereof by reference in its entirety and for all purposes.

### BACKGROUND OF THE INVENTION

The present invention relates to the field of magnetic field assisted internal and external surface finishing of non-magnetic workpieces. More specifically, the present invention relates to the implementation of dynamic (rotating, oscillating, or other designated pattern) magnetic fields generated by stationary electromagnets to generate relative motion between magnetic abrasive particles and a workpiece to facilitate a cutting action (material removal).

Additive manufacturing (AM) due to its freeform nature is a flexible manufacturing process that can generate complex components without the need of complicated assembly mechanisms using various techniques such as powder bed fusion or selective laser melting. It facilitates the design of complex geometries such as conformal cooling passages in turbine blades, which are either very expensive or impractical with traditional machining methods (milling, dies etc.). However, due to uncertainties and complex nonlinear nature of hundreds of parameters ranging from melt pool temperature to velocity, the surface roughness of the manufactured product is not controllable and hence requires post-processing. The average surface roughness is critical for applications requiring strict tolerance adherence such as aviation and medical implants. Post processing of additively manufactured components by hand is not an efficient option as it may raise production costs, increase deviations in surface quality and may restrict having different variations in surface roughness. Therefore, achievement of these characteristics becomes a functional requirement as it ensures the best possible functionality and performance. Conventionally available finishing processes such as bonnet polishing, vibration assisted polishing and fluid jet polishing, sandblasting and the like are some of the techniques used to achieve the desired surface roughness, alter mechanical properties (such as residual stresses) and remove excess material from machined components. However, the time-consuming nature, susceptibility to quasi state errors and high sensitivity to process parameters and outcomes are some of the key driving factors that initiate the search for alternate and non-conventional finishing techniques.

Magnetic Abrasive Finishing (MAF) is a flexible micromachining process designed to alter the surface profile of a part based on the action of a magnetic field on ferromagnetic particles by removing thin micro or nano scale layer in the form of fine chips. MAF has already been used to clean various materials and geometries ranging from flat surfaces to complex shapes such as hollow and solid cylindrical tubes. The surface finishing action takes place due to the relative motion between the workpiece and an abrasive mixture carried by the magnetic field. Under the effect of a magnetic field these magnetic abrasive particles (MAPs) align in the direction of the magnetic flux lines, transforming them to semi solid chains. Therefore, one of the most critical steps in designing a MAF setup is generating relative motion between the MAPs and the workpiece. In conventional MAF setups, a RMF is generated by mechanically rotating permanent magnets, electromagnets, or the workpiece itself. However, these methods are pre-tuned for a specific part and require a process overhaul if the design requirements are modified.

For many industries the surface profiles are not regular in shape like optical lenses and medical implants. Hence, there is a considerable need for a new surface finishing system and method which eliminates the need for rotating mechanical components to generate the required characteristics of the magnetic field. Such a system and method should exhibit flexibility to quickly adapt in accordance with the shape and surface roughness requirements.

The methods, apparatus, and systems of the present invention provide the foregoing and other advantages.

### SUMMARY OF THE INVENTION

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description below and the drawings.

The present invention relates methods, apparatus, and systems for the implementation of dynamic magnetic fields generated by stationary electromagnets to produce relative motion between magnetic abrasive particles and a workpiece to facilitate a cutting action (material removal). The dynamic magnetic field may be in the form of a rotating magnetic field, an oscillating magnetic field or any other type of pattern of motion, which can be created on demand based on the number and arrangement of electromagnets used (e.g., zigzag, plus sign, triangle, square, reciprocating in multiple directions, star motion, Octa, Hegza, and the like).

It is an objective of present disclosure to obviate or mitigate at least one limitation of conventional Magnetic Abrasive Finishing processes. The present methods, apparatus, and systems of the present invention provide the ability to reduce the surface roughness of a non-magnetic workpiece by facilitating material removal due to the relative motion between the Magnetic Abrasive Particles (MAPs) and the workpiece. The relative motion is a result of the interaction of the MAPs with dynamic magnetic fields generated via a stationary electromagnet array. More particularly, the dynamic magnetic field may be rotating or oscillating in nature.

In one example embodiment of the present invention, a system for magnetic field assisted abrasive finishing of a workpiece is provided. The system may comprise a stationary electromagnetic array comprised of iron core electromagnets positioned to generate a dynamic magnetic field and a control system adapted to be programmed to selectively energize the electromagnets of the stationary electromagnetic array to generate the dynamic magnetic field. A plurality of magnetic abrasive particles is also provided. A jig is provided to position the stationary electromagnetic array adjacent to a workpiece. The plurality of magnetic abrasive particles are introduced into the dynamic magnetic field and are caused to move relative to a surface of the workpiece by the dynamic magnetic field.

The control system may comprise a programmable DC power supply for supplying DC power, a power distribution module connected to the DC power supply, a plurality of motor drives, each of the motor drives being connected to the power distribution module and adapted to provide current waveforms to a respective one of the electromagnets of the stationary electromagnetic array, and a control unit comprising a host computer with a corresponding simulator for adjusting a magnetic flux density produced by each of the electromagnets by controlling attributes of the current waveforms energizing the respective electromagnets. The simulator sends analog/digital signals to the motor drives and the motor drives produce the corresponding current waveform.

The current waveforms are capable of altering at least one of a strength of the dynamic magnetic field, an activation frequency of the dynamic magnetic field, or a direction of the dynamic magnetic field.

The control system may be configured to send analog and digital voltage command signals to corresponding motor drives for each of the electromagnets based on stored executable instructions. The command signals may be configured to alter magnitude, speed, and direction of the dynamic magnetic field.

The system may be portable and accommodated on a wheeled platform.

The dynamic magnetic field comprises one of a rotating magnetic field, an oscillating magnetic field, or a designated pattern.

Each of the electromagnets may comprise a pure iron core, a copper coil wound around the iron core, and a pure iron core tip. The iron core tip may be interchangeable. Multiple iron core tips may be provided in different shapes and sizes based on a shape and size of the workpiece and the required flux density.

The copper coil may be wound in a tapered manner at one end of the iron core to reduce a distance between adjacent electromagnets. Alternatively, each of the electromagnets may comprise pen shaped electromagnets enabling a reduced distance between adjacent electromagnets and positioning adjacent nonuniform workpieces and workpieces of varying size while producing a uniform magnetic field and required motion of the magnetic abrasive particles.

The workpiece may comprise any non-magnetic object having at least one of external and internal surfaces to be polished. Further, the workpiece may comprise one of curved profiles, complex-curved-profiles, irregular shapes, and regular shapes. Thus, the interior or exterior of the workpiece to be polished can be of varying geometries.

The electromagnet array may comprise an even number of electromagnets arranged in a particular manner to produce a desired motion pattern (e.g., the electromagnets may be arranged in a circular array to produce a rotating magnetic field). Each electromagnet may be tapered at one end to reduce distance between adjacent electromagnets and introduce a greater number of electromagnets into the array as compared to conventional cylindrical electromagnets. The electromagnets may also be designed having a smaller diameter (e.g., pen-shaped) to increase the finishing efficiency and reduce locations of low magnetic flux density.

When the MAPs are introduced to a rotating magnetic field, the MAPs follow the magnetic flux lines from one magnetic pole to the adjacent magnetic pole due to the gradient of the magnetic field.

The present invention also encompasses a method for magnetic field assisted abrasive finishing of a workpiece. In one example embodiment, the method may comprise providing a stationary electromagnetic array comprised of iron core electromagnets positioned to generate a dynamic magnetic field, positioning the stationary electromagnetic array adjacent to a workpiece, selectively energizing the electromagnets of the stationary electromagnetic array to generate the dynamic magnetic field, and introducing a plurality of magnetic abrasive particles into the dynamic magnetic field. The magnetic abrasive particles are caused to move relative to a surface of the workpiece by the dynamic magnetic field.

The method may further include any or all of the features and functionality mentioned above in connection with the system embodiments. Corresponding apparatus are also provided in accordance with the present invention.

### BRIEF DESCRIPTION OF THE DRAWINGS

The present invention will hereinafter be described in conjunction with the appended drawing figures, wherein like reference numerals denote like elements, and:

FIG. 1 shows a flowchart of an example embodiment of a system in accordance with the present invention;

FIG. 2 shows a sub-system level schematic of an example embodiment of a system in accordance with the present invention;

FIG. 3 shows an example embodiment of an electromagnetic array arranged about a hollow cylindrical workpiece in accordance with the present invention;

FIG. 4 shows an example embodiment of an electromagnetic array arranged about a flat sheet workpiece in accordance with the present invention;

FIG. 5A shows an example embodiment of an electromagnetic array generating a rotating magnetic field in accordance with the present invention;

FIG. 5B shows an example embodiment of an electromagnetic array generating an oscillating magnetic field in accordance with the present invention;

FIG. 6 shows the example embodiment of FIG. 5 with the introduction of magnetic abrasive particles into the dynamic magnetic field in accordance with the present invention;

FIG. 7A shows an example embodiment of a jig holding an electromagnetic array in accordance with the present invention;

FIG. 7B shows the example embodiment of the jig of FIG. 7A, without the electromagnetic array in accordance with the present invention;

FIG. 8 shows an example embodiment of individual current waveforms for energizing an embodiment comprised of four electromagnets to generate a rotating magnetic field in accordance with the present invention;

FIG. 9 shows the phase difference between the current waveforms of FIG. 8 in accordance with the present invention;

FIG. 10 shows an example embodiment of a tapered electromagnet designed to reduce the distance between adjacent electromagnets in a circular array in accordance with the present invention;

FIG. 11 shows a cross-section of the tapered electromagnet of FIG. 10 in accordance with the present invention;

FIG. 12A shows an example embodiment of a tapered electromagnet fitted with a core tip in accordance with the present invention;

FIG. 12B shows an example embodiment of an electromagnet (without any taper) fitted with a core tip in accordance with the present invention;

FIG. 13 shows an example embodiment of an interchangeable core tip in accordance with the present invention;

FIG. 14 shows example embodiments of various interchangeable core tips of varying geometries in accordance with the present invention;

FIG. 15 shows an exemplary embodiment a circular electromagnetic array which comprises of a plurality of pen-shaped electromagnets in accordance with the present invention;

FIG. 16 shows a three-dimensional map of an initial and final surface profile of an area of a workpiece after implementation of the method of the present invention; and

FIG. 17 shows a chart of the roughness profile along a line of the workpiece represented in FIG. 16 before and after polishing.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

In a typical MAF process the cutting/chipping action is a result of two forces generated due to the gradient of the magnetic field: the normal component and the tangential component. The normal component is responsible for the indentation of the MAPs in the workpiece and is generated due to the force acting on the magnetic particles between opposite magnetic poles. The tangential component of the force is responsible for the final chipping action as it overcomes the shear stress of the material. Conventionally, permanent electromagnets are mounted on rotating machinery such as milling and lathe machines to create the tangential component by generating a rotating magnetic field. Hence, this makes the setup very bulky and almost impossible to be portable.

To overcome the limitations of the conventional MAF technique and to implement the techniques disclosed herein, a physical system was designed and fabricated while prioritizing portability and flexibility of the process. The primary function of the system of the present invention is to generate a rotating magnetic field in order to manipulate the motion of the magnetic abrasive particles on the surface of the workpiece without using any rotational or translational motion of the electromagnets during the process. The entire system is developed on a multi-level portable platform capable of sustaining shocks, vibrations and shopfloor environments.

Disclosed in detail below are exemplary embodiments of a method and system to remove material and reduce surface roughness of physically hard-to-reach external and internal surfaces of a non-magnetic workpiece using stationary electromagnets. The method is based on the implementation of dynamic magnetic fields (rotating or oscillating magnetic fields) on magnetic abrasive particles (MAPs). The MAPs, in response to the dynamic magnetic field, move along the magnetic field lines and a relative motion is achieved between MAPs and the workpiece. Unlike conventional Magnetic Abrasive Finishing, this technique does not involve any moving parts/components to impart a rotating motion to either the magnet/electromagnet or the workpiece. The motion of the MAPs generates a plurality of grooves on the workpiece surface. The stationary iron core electromagnets are arranged in an array to generate the dynamic magnetic field. The embodiments below also include a control unit that can be configured to adjust the magnetic flux density based on a working gap between the electromagnets and the workpiece.

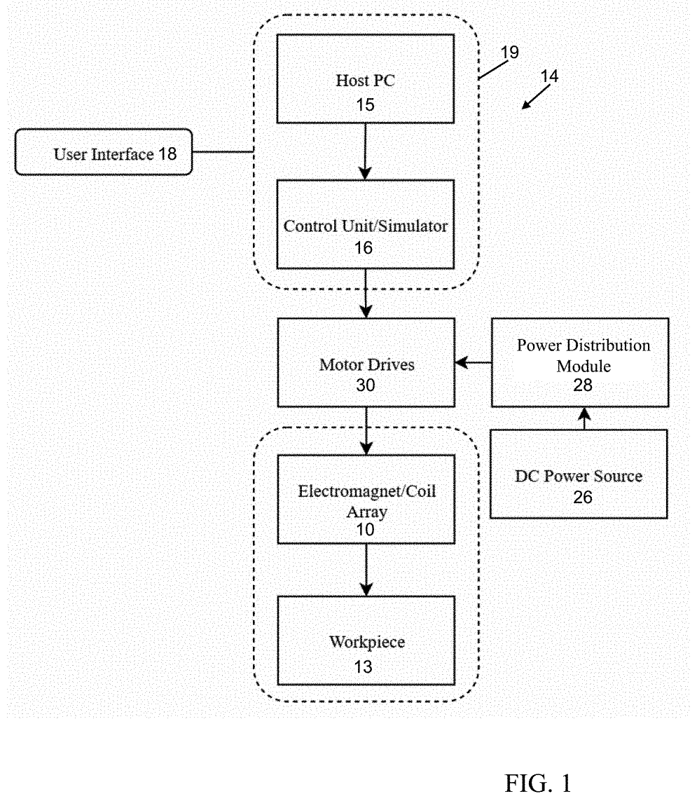

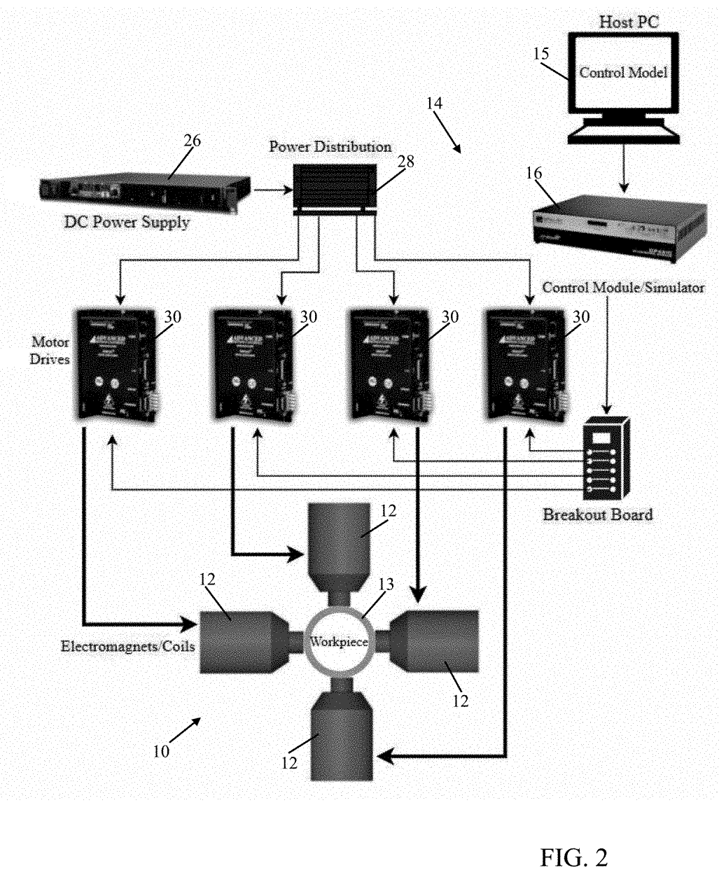

The present invention is directed to a system for magnetic field assisted abrasive finishing of a workpiece using stationary electromagnets. FIGS. 1-4 illustrate an exemplary embodiment of such a system, which may include a stationary electromagnetic array 10 comprised of iron core electromagnets 12 positioned to generate a dynamic magnetic field. The system also comprises a control system 14 adapted to be programmed (e.g., via a user interface 18 connected to a control unit 19) to selectively energize the electromagnets 12 of the stationary electromagnetic array 10 to generate the dynamic magnetic field.

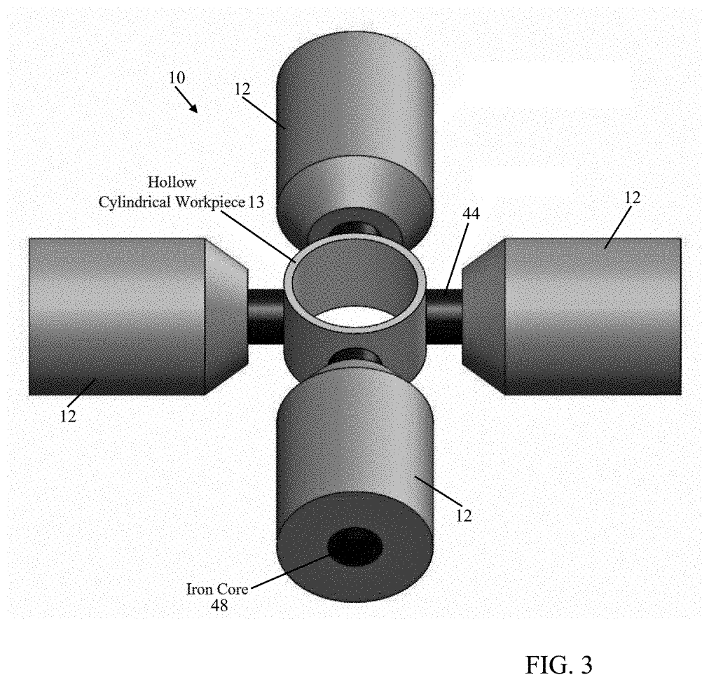

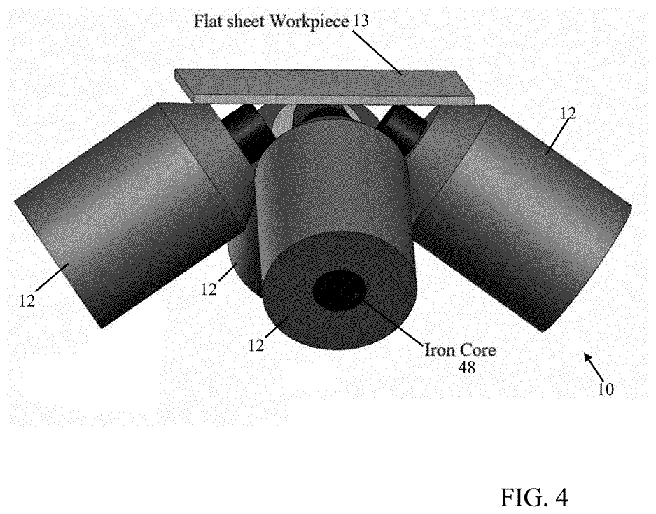

FIG. 3 shows a cylindrical workpiece 13 positioned adjacent the array 10. FIG. 4 shows a flat workpiece 13 positioned adjacent the array 10.

The dynamic magnetic field may comprise one of a rotating magnetic field, an oscillating magnetic field, or a designated pattern which can be created on demand based on the number and arrangement of electromagnets used (e.g., zigzag, plus sign, triangle, square, reciprocating in multiple directions, star motion, Octa, Hegza, and the like).

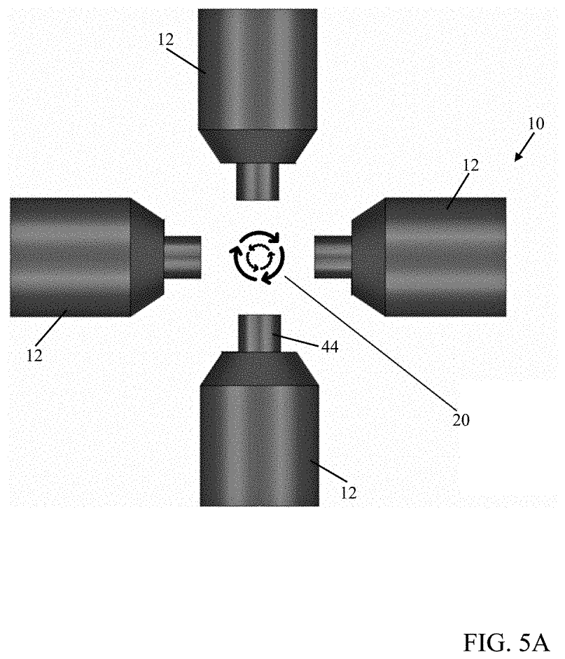

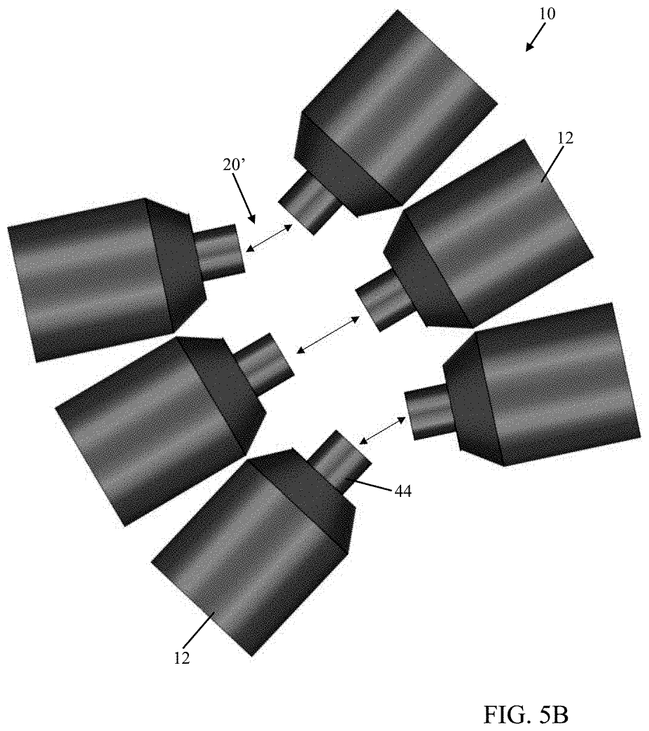

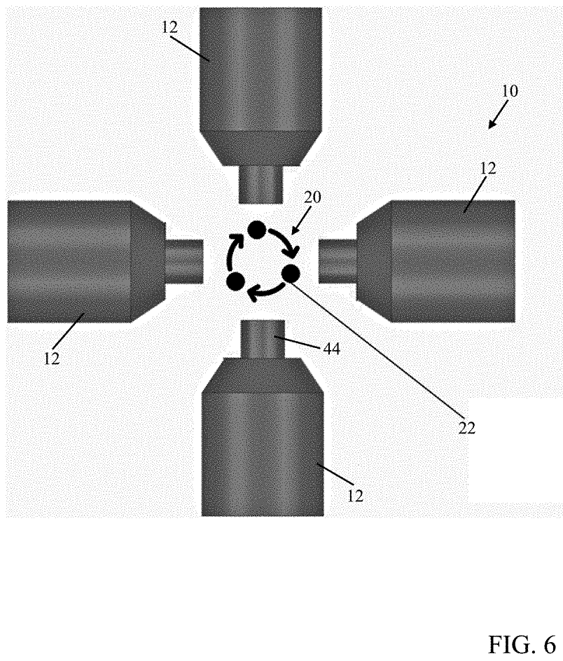

FIG. 5A illustrates the dynamic magnetic field in the form of a rotating magnetic field 20 created by the electromagnetic array 10 (which can be a clockwise or counterclockwise rotating field as shown). As shown in FIG. 6, a plurality of magnetic abrasive particles 22 are introduced into the dynamic (rotating) magnetic field 20 and are caused to move relative to a surface of the workpiece 13 by the dynamic magnetic field 20.

FIG. 5B illustrates an example embodiment of a stationary electromagnetic array 10 that produces an oscillating magnetic field 20′.

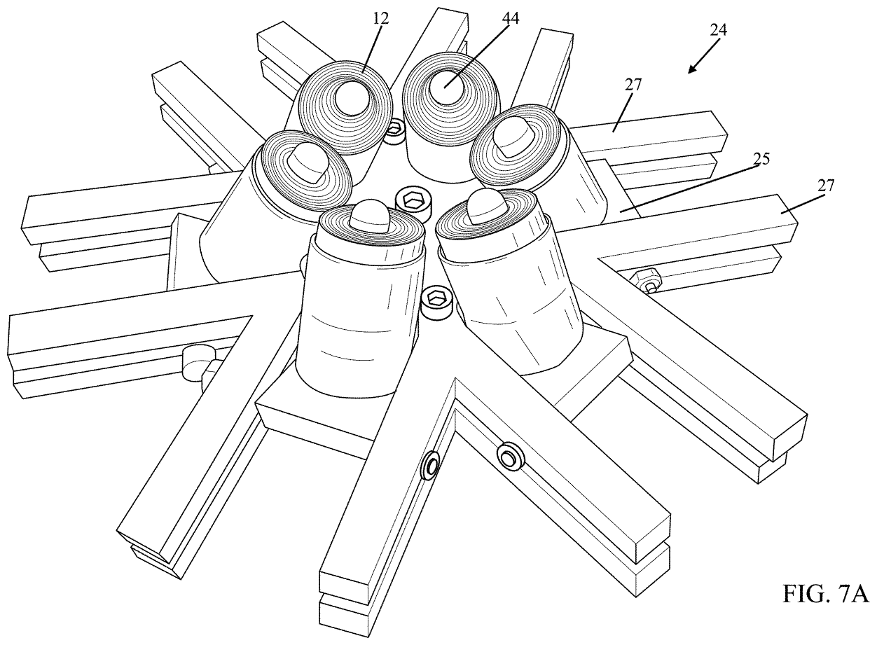

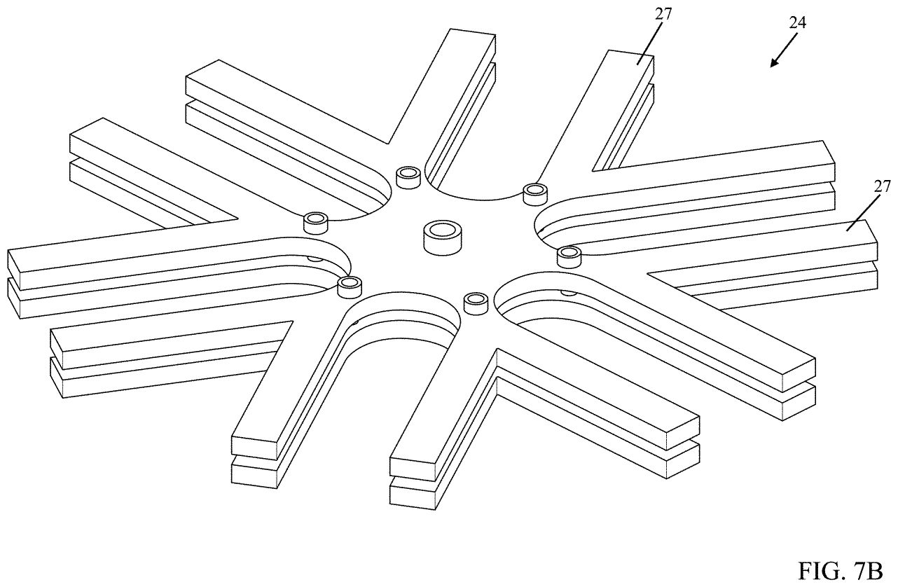

FIGS. 7A and 7B shows an example embodiment of a jig 24 that may be used to position the workpiece 13 adjacent to the stationary electromagnetic array 10. FIG. 7A shows an example embodiment of an electromagnetic array 10 positioned in the jig 24. FIG. 7B shows the jig 24 without the electromagnetic array 10. The jig 24 may comprise frame arms 25 that can be manipulated along multiple axis to change position, orientation, and relative location of individual electromagnets in reference to the workpiece. The test jig 24 may be comprised of a frame 27 for holding the workpiece. DC fans (not shown) may be provided for heat dissipation of the electromagnets 12.

The modular nature of the system allows the operator to change the core tip shapes, angle and location of coils, current, amplitude, frequency and phase difference at any instant. Moreover, the entire setup may be mounted on wheels which can be easily moved and safely secured at any location.

The control system 14 may comprise a programmable DC power supply 26 for supplying DC power, a power distribution module 28 connected to the DC power supply 26, a plurality of motor drives 30, each of the motor drives 30 being connected to the power distribution module 28 and adapted to provide current waveforms to a respective one of the electromagnets 12 of the stationary electromagnetic array 10, and a control unit 19 comprising a host computer 15 with a corresponding simulator 16 (e.g., an FPGA simulator) for adjusting a magnetic flux density produced in the workspace by each of the electromagnets 12, by controlling attributes of the current waveforms energizing the respective electromagnets 12. A user interface 18 enables a user to provide inputs to the host computer 15. The output from the DC power supply 26 may be distributed by the power distribution module 28 via a slow blow fuse (fuse current ratings may vary with the number of coils in use).

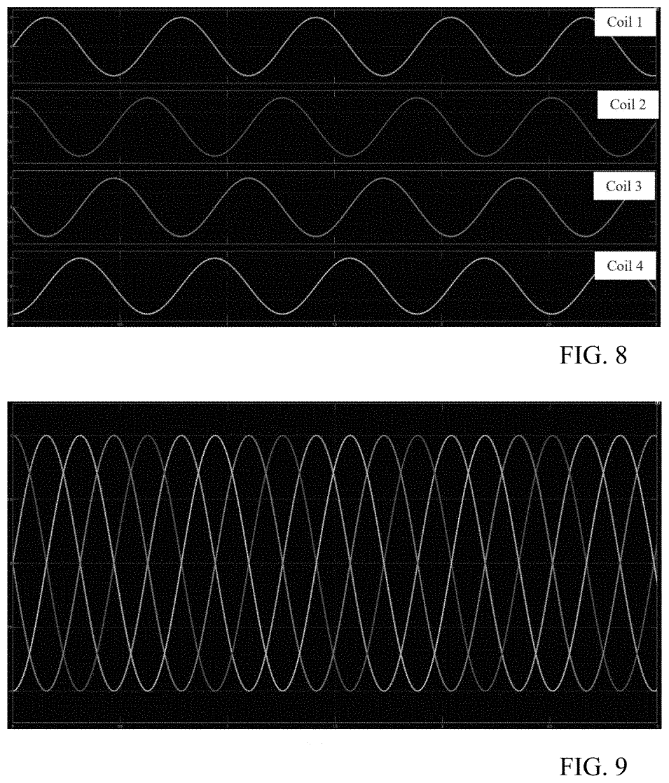

The control unit 19 may control (via analog/digital signals) the output current waveform of the motor drives 30. The host computer 15 is used as an interface between the operator and the apparatus. The process parameters (waveform, frequency, amplitude, and phase difference) can be monitored and changed real time on a display mounted on the apparatus. The control model for the disclosed technique is an open loop model built in e.g., MATLAB-Simulink. The control unit 19 is designed to energize the electromagnets 12 via sine wave currents having an appropriate phase difference between them based on the number of even coils being implemented. Examples of such waveforms are shown in FIGS. 8 and 9. FIG. 8 illustrates the individual current waveforms energizing an array comprised of four electromagnets 12 to generate a rotating magnetic field 20. FIG. 9 illustrates the phase difference between the current waveforms of FIG. 8. Other waveforms can also be used.

The current waveforms are capable of altering at least one of a strength of the dynamic magnetic field 20, an activation frequency of the dynamic magnetic field 20, or a direction of the dynamic magnetic field 20. In an exemplary embodiment, the motor drives 30 are programmed to generate current waveforms emulating analog/digital command voltage signals from the control unit 19. In particular, the control system 14 may be configured to send analog and digital voltage command signals to corresponding motor drives 30 for each of the electromagnets 12 based on stored executable instructions. The motor drives 30 adjust the output duty cycle to maintain the commanded output current. The command signals may be configured to alter magnitude, speed, and direction of the rotating magnetic field 20.

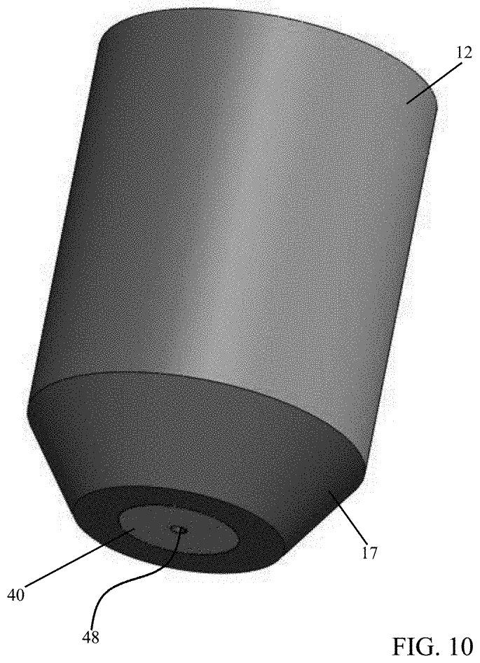

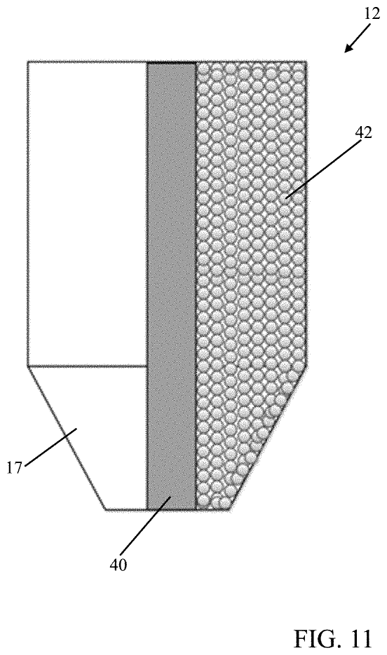

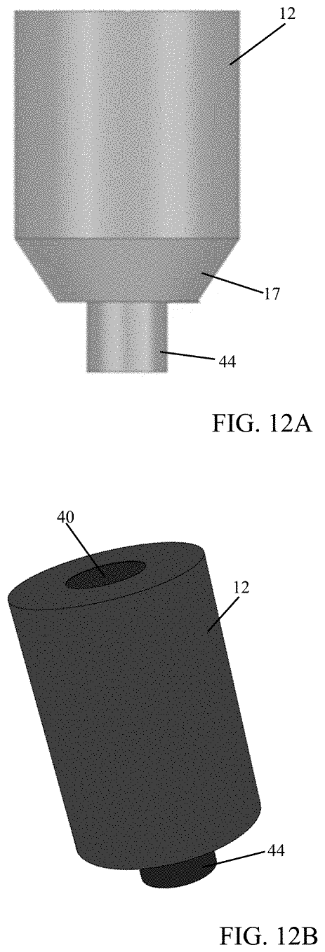

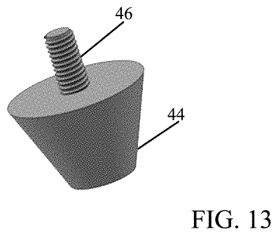

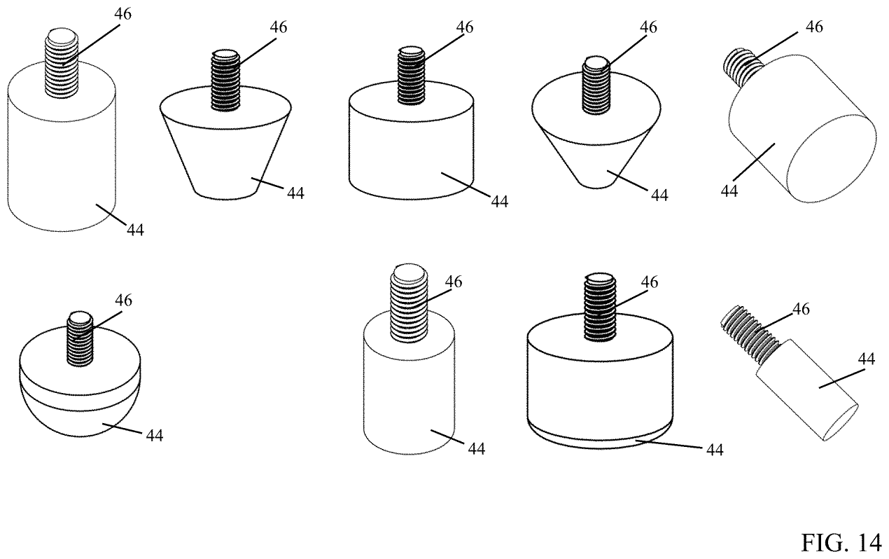

FIGS. 10 shows an example embodiment of an electromagnet 12 in accordance with the present invention. FIG. 11 shows a cross-section of such an electromagnet 12. The electromagnets 12 may comprise a pure iron core 40, a copper coil 42 wound around the iron core 40, and a pure iron core tip 44 (as shown in FIGS. 12A and 12B). The iron core tip 44 may be interchangeable. For example, as shown in FIG. 13, the tip 44 may include a threaded rod 46 adapted to be screwed into a corresponding screw hole 48 in the electromagnet 12. Multiple iron core tips 44 may be provided in different shapes and sizes, as illustrated in FIG. 14.

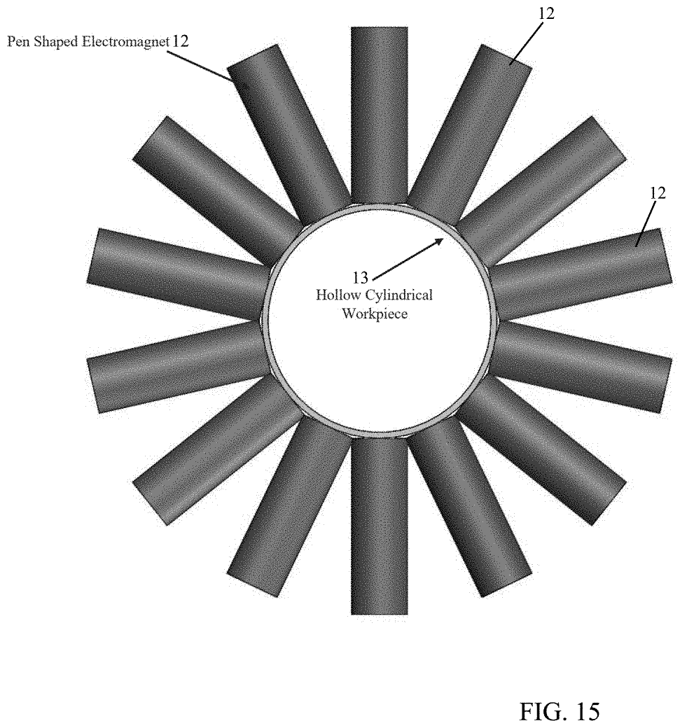

As shown in FIG. 12A, the copper coil 42 may be wound in a tapered manner at one end (e.g., tapered section 17) of the iron core 40 to reduce a distance between adjacent electromagnets and maintain a uniform distribution of the magnetic field in the workspace. Alternatively, as shown in FIG. 15, each of the electromagnets 12 may comprise pen-shaped (e.g., thin cylindrical) electromagnets. The pen-shaped electromagnets may have a smaller diameter than the tapered electromagnets and may be provided with or without an iron core. This pen shape enables a reduced distances between adjacent electromagnets 12 and positioning of the electromagnets adjacent nonuniform workpieces and workpieces of varying size, while producing a uniform magnetic field.

The coil design is optimized using both analytical and finite element analysis to maximize the gradient of magnetic field on both the axis and off-axis locations. The magnetic field gradient can be significantly magnified by selecting an appropriate core tip shape and core material as the core tip is used to direct and concentrate the magnetic flux lines in the working spot. Moreover, use of an extended core tip 44 can also result in reduced leakage of the magnetic flux. Iron may be selected for the core tip 44 as it has one of the highest relative permeability (4000) amongst metals.

The workpiece 13 may comprise any non-magnetic object having at least one of external and internal surfaces to be polished. Further, the workpiece 13 may comprise one of curved profiles, complex-curved-profiles, irregular shapes, and regular shapes. Thus, the interior or exterior of the workpiece 13 to be polished can be of varying geometries.

The present invention also encompasses a method for magnetic field assisted abrasive finishing of a workpiece 13. In one example embodiment, the method may comprise providing a stationary electromagnetic array 10 comprised of iron core electromagnets 12 positioned to generate a dynamic magnetic field 20, positioning the workpiece 13 adjacent to the stationary electromagnetic array 10, selectively energizing the electromagnets 12 of the stationary electromagnetic array to generate the dynamic magnetic field 20, and introducing a plurality of magnetic abrasive particles 22 into the dynamic magnetic field 20. The magnetic abrasive particles 22 are caused to move relative to a surface of the workpiece 13 by the dynamic magnetic field 20.

The method may further include any or all of the features and functionality of the above-mentioned systems and apparatus.

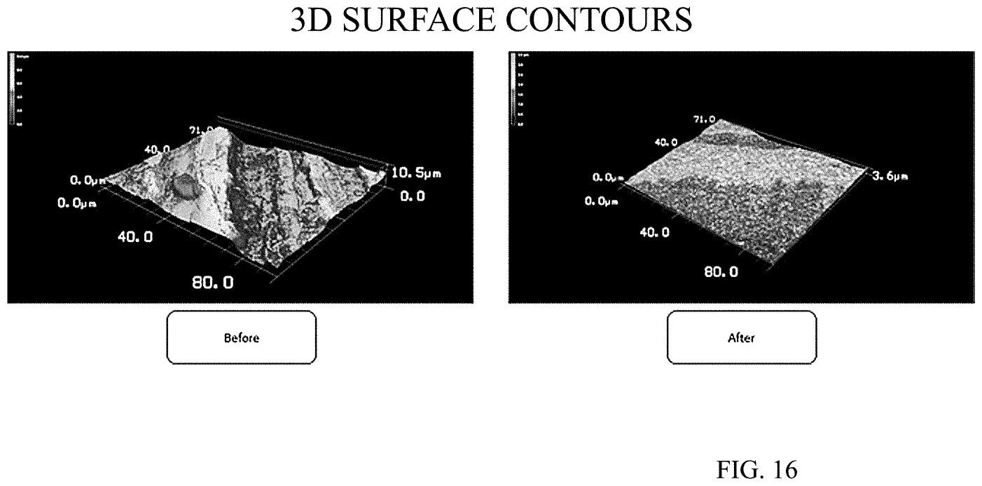

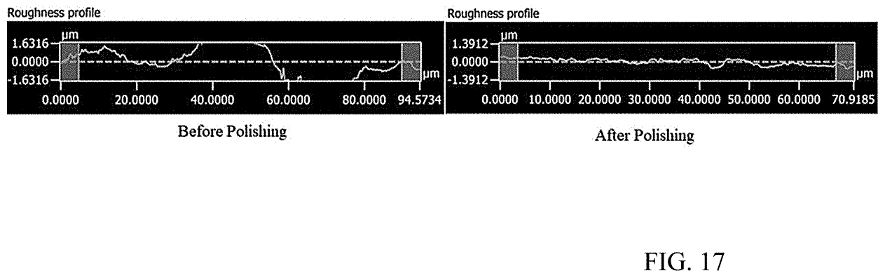

FIG. 16 illustrates a three-dimensional map of an initial and a final surface profile of the workpiece after implementation of the method disclosed. FIG. 17 illustrates a chart showing the changes in average surface roughness of the workpiece under a laser confocal microscope after implementation of the method disclosed. As can be seen in FIG. 17, the method of the present invention was not only able to reduce peaks and troughs in the surface contour of the workpiece, but also to achieve a uniform surface roughness.

It should now be appreciated that the present invention provides advantageous methods and apparatus for magnetic field assisted abrasive finishing of workpieces using a stationary electromagnetic array.

Although the invention has been described in connection with various illustrated embodiments, numerous modifications and adaptations may be made thereto without departing from the spirit and scope of the invention as set forth in the claims.

What is claimed is:

1. A system for magnetic field assisted abrasive finishing of a workpiece, comprising:
a stationary electromagnetic array comprised of iron core electromagnets positioned to generate a dynamic magnetic field;
a control system adapted to be programmed to selectively energize the electromagnets of the stationary electromagnetic array to generate the dynamic magnetic field;
a plurality of magnetic abrasive particles; and
a jig to position the stationary electromagnetic array adjacent to a workpiece;
wherein the plurality of magnetic abrasive particles are introduced into the dynamic magnetic field and are caused to move relative to a surface of the workpiece by the dynamic magnetic field.

2. The system in accordance with claim 1, wherein the control system comprises:
a programmable DC power supply for supplying DC power;
a power distribution module connected to the DC power supply;
a plurality of motor drives, each of the motor drives being connected to the power distribution module and adapted to provide current waveforms to a respective one of the electromagnets of the stationary electromagnetic array; and
a control unit comprising a host computer with a corresponding simulator for adjusting a magnetic flux density produced by each of the electromagnets by controlling attributes of the current waveforms energizing the respective electromagnets;
wherein the simulator sends analog/digital signals to the motor drives and the motor drives produce the corresponding current waveform.

3. The system in accordance with claim 2, wherein the current waveforms are capable of altering at least one of a strength of the dynamic magnetic field, an activation frequency of the dynamic magnetic field, or a direction of the dynamic magnetic field.

4. The system in accordance with claim 1, wherein:
the control system is configured to send analog and digital voltage command signals to corresponding motor drives for each of the electromagnets based on stored executable instructions; and
the command signals are configured to alter magnitude, speed, and direction of the dynamic magnetic field.

5. The system in accordance with claim 1, wherein the dynamic magnetic field comprises one of a rotating magnetic field, an oscillating magnetic field, or a designated pattern.

6. The system in accordance with claim 1, wherein each of the electromagnets comprises:
a pure iron core;
a copper coil wound around the iron core; and
a pure iron core tip.

7. The system in accordance with claim 6, wherein:
the iron core tip is interchangeable; and
multiple iron core tips are provided in different shapes and sizes based on a shape and size of the workpiece and the required flux density.

8. The system in accordance with claim 6, wherein the copper coil is wound in a tapered manner at one end of the iron core to reduce a distance between adjacent electromagnets.

9. The system in accordance with claim 1, wherein each of the electromagnets comprise pen shaped electromagnets enabling a reduced distance between adjacent electromagnets and positioning adjacent nonuniform workpieces and workpieces of varying size while producing a uniform magnetic field and required motion of the magnetic abrasive particles.

10. The system in accordance with claim 1, wherein:
the workpiece comprises any non-magnetic object having at least one of external and internal surfaces to be polished; and
the workpiece comprises one of curved profiles, complex-curved-profiles, irregular shapes, and regular shapes.

11. A method for magnetic field assisted abrasive finishing of a workpiece, comprising:
providing a stationary electromagnetic array comprised of iron core electromagnets positioned to generate a dynamic magnetic field;
positioning the stationary electromagnetic array adjacent to a workpiece;
selectively energizing the electromagnets of the stationary electromagnetic array to generate the dynamic magnetic field; and
introducing a plurality of magnetic abrasive particles into the dynamic magnetic field,
wherein the magnetic abrasive particles are caused to move relative to a surface of the workpiece by the dynamic magnetic field.

12. The method in accordance with claim 11, wherein a control system is provided for selectively energizing the electromagnets, the control system comprising:
a programmable DC power supply for supplying DC power;
a power distribution module connected to the DC power supply;
a plurality of motor drives, each of the motor drives being connected to the power distribution module and adapted to provide current waveforms to a respective one of the electromagnets of the stationary electromagnetic array; and
a control unit comprising a host computer with a corresponding simulator for adjusting a magnetic flux density produced by each of the electromagnets by controlling attributes of analog or digital voltage command signals sent to the motor drives;
wherein the simulator sends analog/digital signals to the motor drives and the motor drives produce the corresponding current waveform.

13. The method in accordance with claim 12, wherein the current waveforms are capable of altering at least one of a strength of the magnetic field, an activation frequency of the dynamic magnetic field, or a direction of the dynamic magnetic field.

14. The method in accordance with claim 12, wherein:
the control system is configured to send analog and digital voltage command signals to corresponding motor drives for each of the electromagnets based on stored executable instructions; and
the command signals are configured to alter magnitude, speed, and direction of the dynamic magnetic field.

15. The method in accordance with claim 11, wherein the dynamic magnetic field comprises one of a rotating magnetic field, an oscillating magnetic field, or a designated pattern.

16. The method in accordance with claim 11, wherein each of the electromagnets comprises:
a pure iron core;
a copper coil wound around the iron core; and
a pure iron core tip.

17. The method in accordance with claim 16, wherein:
the iron core tip is interchangeable; and
multiple iron core tips are provided in different shapes and sizes based on a shape and size of the workpiece and the required flux density.

18. The method in accordance with claim 16, wherein the copper coil is wound in a tapered manner at one end of the iron core to reduce a distance between adjacent electromagnets.

19. The method in accordance with claim 11, wherein each of the electromagnets comprise pen shaped electromagnets enabling a reduced distance between adjacent electromagnets and positioning adjacent nonuniform workpieces and workpieces of varying size while producing a uniform magnetic field and required motion of the magnetic abrasive particles.

20. The method in accordance with claim 11, wherein:
the workpiece comprises any non-magnetic object having at least one of external and internal surfaces to be polished; and
the workpiece comprises one of curved profiles, complex-curved-profiles, irregular shapes, and regular shapes.
